(19) United States
(12) Patent Application Publication
(10) Pub. No.: US 2022/0341804 A1
(43) Pub. Date: Oct. 27, 2022

(54) SENSOR ASSEMBLY FOR REFRIGERANT LEAK DETECTION

(71) Applicant: Therm-O-Disc Incorporated, Mansfield, OH (US)

(72) Inventor: Jeffrey A. West, Bellville, OH (US)

(21) Appl. No.: 17/717,455

(22) Filed: Apr. 11, 2022

Related U.S. Application Data
(60) Provisional application No. 63/179,820, filed on Apr. 26, 2021.

(51) Int. Cl. G01M 3/02

(52) U.S. Cl. CPC G01M 3/02

(57) ABSTRACT

A refrigerant sensor assembly having a body including an outer surface. A recessed portion may be included on or formed in the body. The recessed portion may include the outer surface. The recessed portion may have a curved, generally convex shape having an upwardly facing open end and a lowest portion or bottom opposite the upwardly facing open end. A sensor suitable for detecting the presence of a refrigerant (e.g., a lower GWP refrigerant and/or an A2L refrigerant) and/or certain specified chemical compounds (e.g., hydrofluorocarbons) (e.g., a refrigerant sensor) may be disposed at the bottom of the recessed portion. Alternatively an enclosed collection space may be located beneath the recessed portion. An aperture or opening may be formed through the recessed portion and may adjoin the recessed portion with the collection space. A refrigerant sensor alternatively may be disposed in the collection space.

### CROSS-REFERENCE TO RELATED APPLICATIONS

This Application claims the benefit of U.S. Provisional Application 63/179,820 filed on Apr. 26, 2021. The entire disclosure of the above application is incorporated herein by reference.

### TECHNICAL FIELD

The invention set forth in the appended claims relates generally to air conditioning systems and more particularly, but without limitation, to leak detection systems and sensors for use in air conditioning systems.

### BACKGROUND

Hydrocarbon-based refrigerants have been used as working fluids in the heat pump and refrigeration cycle of conventional air conditioning and refrigeration systems. Fluorocarbons, such as chlorofluorocarbons (CFC), hydrochlorofluorocarbons (HCFC) and hydrofluorocarbons (HFC) became commonplace in air conditioning and refrigeration systems in the 20th century due to their favorable thermodynamic properties, their non-flammability, and their non-toxicity. However, while the inert nature of many CFCs and HCFCs made them preferred choices for use as refrigerants in air conditioning and refrigeration systems for many years, that same inert nature contributed to their long lifecycles in the atmosphere. After the discovery of ozone holes in the stratosphere over the polar regions in the early 1980s, air conditioning and refrigeration systems transitioned to hydrofluorocarbon (HFC) refrigerants which were not ozone depleting, such as R-134a, R-143a, and R-410A. In the early 21st century, new refrigerants were developed to be even safer for the environment. These new refrigerants are commonly referred to as lower global warming potential (GWP) refrigerants.

The American Society of Heating, Refrigeration, and Air Conditioning Engineers (ASHRAE) has promulgated standards classifying various refrigerants according to their toxicity and flammability. For example, ASHRAE Standard 34 classifies refrigerants having a lower toxicity as Class A refrigerants, and refrigerants having a higher toxicity as Class B refrigerants. The flammability class of refrigerants is determined according to ASTM E681, Standard Test Method for Concentration Limits of Flammability of Chemicals (Vapors and Gases) at a temperature of 60° C. and a pressure of 101 kPa. According to ASHRAE Standard 34, Class 1 refrigerants do not propagate a flame, Class 2L refrigerants have a lower flammability and a slow flame propagation (for example, a burning velocity less than 10 cm/s), Class 2 refrigerants have lower flammability and faster flame propagation (for example, a burning velocity of greater than 10 cm/s), while Class 3 refrigerants have a higher flammability and faster flame propagation (for example, a burning velocity greater than 10 cm/s). Under the ASHRAE Standard 34, the commonly used R-410A refrigerant has a Class A toxicity classification and a Class 1 flammability classification. Thus, R-410A is referred to as an A1 refrigerant under ASHRAE Standard 34.

New lower GWP refrigerants include, but are not limited to, refrigerants such as R-1234yf, R-1234ze, R-32, R-454A, R-454C, R-455A, R-447A, R-452B, and R-454B. These refrigerants have a Class A toxicity classification and a Class 2L flammability classification under ASHRAE Standard 34. Thus, these refrigerants may be referred to as A2L refrigerants. Because A2L refrigerants have the ability to propagate a flame, precautions must be taken to prevent the accidental build-up of A2L refrigerants, particularly in enclosed spaces. However, A2L refrigerants will not ignite if their concentration level is below their lower flammability limit. Thus, there is the need to provide apparatus, systems, and methods for detecting A2L refrigerant leaks and the build-up of A2L refrigerants in air conditioning and refrigeration systems.

### SUMMARY

New and useful systems, apparatuses, and methods for providing a refrigerator unit are set forth in the appended claims. Illustrative embodiments are also provided to enable a person skilled in the art to make and use the claimed subject matter.

In various implementations, the present disclosure also provides a refrigerant sensor assembly having a body including an outer surface. A recessed portion may be included on or formed in the body. The recessed portion may include the outer surface. The recessed portion may have a first volume. Further, the recessed portion may have a curved, generally convex shape having an upwardly facing open end. Alternatively, or in addition, the recessed portion may have a generally hemi-spherical shape. Still further, the recessed portion may take the shape of a bowl. The recessed portion may have a lowest portion or bottom opposite the upwardly facing open end. A sensor suitable for detecting the presence of a refrigerant (e.g., a lower GWP refrigerant and/or an A2L refrigerant) and/or certain specified chemical compounds (e.g., hydrofluorocarbons) (e.g., a refrigerant sensor) may be disposed within the recessed portion. The refrigerant sensor may be disposed at the bottom of the recessed portion.

In other various implementations, the present disclosure provides a refrigerant sensor assembly. For example, the present disclosure provides a refrigerant sensor assembly that may include a body having an exterior surface. A recessed portion may be included on or formed in the body. The recessed portion may include the outer surface. An enclosed collection space may be located beneath the recessed portion. An aperture or opening may be formed through the recessed portion and may adjoin the recessed portion with the collection space. A refrigerant sensor may be disposed in the collection space. The recessed portion may have a first volume. Further, the recessed portion may have a curved, generally convex shape having an upwardly facing open end. Alternatively, or in addition, the recessed portion may have a generally hemi-spherical shape. Still further, the recessed portion may take the shape of a bowl. The recessed portion may have a lowest portion or bottom opposite the upwardly facing open end. The collection space may have a second volume that is smaller than the first volume of the recessed portion. The collection space may have a lowest portion or bottom opposite the aperture. The refrigerant sensor may be disposed at the bottom of the collection space.

In another aspect of the disclosure, a refrigerator unit is also described. The refrigerator unit may include a top wall, a bottom wall, and a plurality of side walls forming a compartment. A recessed portion may be included on or formed in a surface of the bottom wall. An enclosed collection space may be provided and located beneath the recessed portion. An aperture or opening may be formed through the recessed portion and adjoining the recessed portion with the collection space. A refrigerant sensor may be disposed in the collection space.

More generally, a refrigerator unit is also described. The refrigerator unit may include a refrigerated compartment having a bottom wall, a curved surface formed on the bottom wall, and a refrigerant sensor disposed on the curved surface.

Objectives, advantages, and a preferred mode of making and using the claimed subject matter may be understood best by reference to the accompanying drawings in conjunction with the following detailed description of illustrative embodiments.

### DRAWINGS

The drawings described herein are for illustrative purposes only of selected embodiments and not all possible implementations, and are not intended to limit the scope of the present disclosure.

FIG. 1 is a functional block diagram of an example embodiment of a refrigeration cycle system used in refrigeration systems;

FIG. 2 is a front view of an exemplary refrigerator unit utilizing the refrigeration cycle system of FIG. 1;

FIG. 3 is a front view of the refrigerator unit of FIG. 2 with the door removed;

FIG. 4 is a top view of an exemplary sensor assembly;

FIG. 5 is a cross-sectional view of the sensor assembly of FIG. 4, taken at line 5-5, and illustrating additional details that may be associated with some example embodiments of the sensor assembly; and

FIG. 5A is a cross-sectional view similar to FIG. 5 and illustrating additional details that may be associated with some examples of the sensor assembly.

Corresponding reference numerals indicate corresponding parts throughout the several views of the drawings, as applicable.

### DESCRIPTION

The following description of example embodiments provides information that enables a person skilled in the art to make and use the subject matter set forth in the appended claims, but it may omit certain details already well-known in the art. The following detailed description is, therefore, to be taken as illustrative and not limiting.

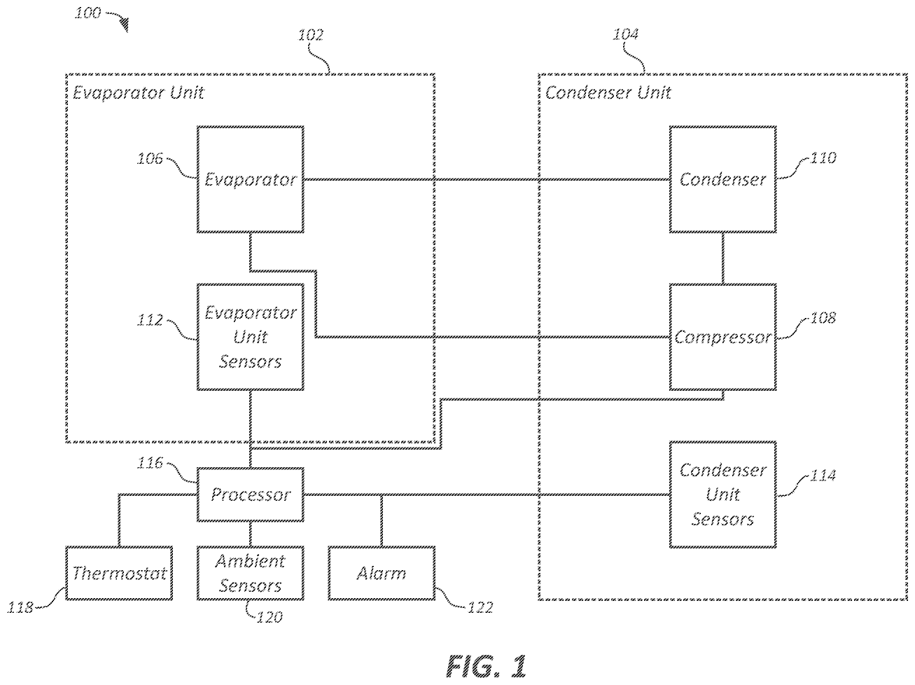

FIG. 1 is a functional block diagram of an example embodiment of a refrigeration cycle system 100 used in refrigeration systems. As shown in FIG. 1, some examples of the system 100 may include an evaporator unit 102 and a condenser unit 104. According to some examples, the evaporator unit 102 may be inside a refrigerator unit (not shown) and referred to as an inside unit, while the condenser unit 104 may be located on the exterior of the refrigerator unit and referred to as an exterior unit. The evaporator unit 102 may include an evaporator 106, such as an evaporator coil, and the condenser unit 104 may include a compressor 108 and a condenser 110. The evaporator 106, compressor 108, and the condenser 110 may be fluidly coupled, such as by a pipe, gas line, or liquid line. For example, the evaporator 106 may be fluidly coupled to the compressor 108 by a suction line. In some examples, the evaporator 106 may be fluidly coupled to the condenser 110 by a liquid line. According to exemplary embodiments, the compressor 108 may be fluidly coupled to the condenser 110 by a hot gas line.

In operation, the compressor 108 may compress a refrigerant, such as an A2L refrigerant. For example, the A2L refrigerant may include R-1234yf, R-1234ze, R-32, R-454A, R-454C, R-455A, R-447A, R-452B, or R-454B. After the refrigerant is compressed by the compressor 108, the hot compressed refrigerant gas may be provided to the condenser 110 through the hot gas line. The condenser 110 cools the hot refrigerant gas, which condenses back into liquid refrigerant. The liquid refrigerant may be transported from the condenser 110 to the evaporator 106 through the liquid line. At the evaporator 106, the liquid refrigerant may expand back into a refrigerant gas. As a result of the refrigerant's phase change from liquid into gas in the evaporator 106, the temperature of the refrigerant is decreased, and the cooled refrigerant gas may absorb heat energy from the evaporator 106, cooling the exterior of the evaporator 106 in the process. A fan (not shown) may provide airflow over the cooled exterior of the evaporator 106. As the air flows over the cooled exterior of the evaporator 106, the evaporator 106 may absorb heat energy from the flowing air, cooling the air. This cooled air may then be provided to a refrigerated environment, such as the interior space of the refrigerator unit.

The system 100 may also include various monitoring and control means, such as sensors, thermostats, and processors. For example, evaporator unit sensors 112 may be provided within a housing member of the evaporator unit 102, and condenser unit sensors 114 may be provided within a housing member of the condenser unit 104. The evaporator unit sensors 112 and condenser unit sensors 114 may be operatively coupled to a processor 116. In some examples, a thermostat 118 may be provided to monitor the refrigerated environment. The thermostat 118 may also be operatively coupled to the processor 116. In illustrative embodiments, additional ambient sensors 120 may also be provided and operatively coupled to the processor 116. The evaporator unit sensors 112, condenser unit sensors 114, and/or ambient sensors 120 may include sensors suitable for detecting a presence of a refrigerant, such as a lower GWP refrigerant and/or an A2L refrigerant. Upon detecting the presence of the refrigerant, the evaporator unit sensors 112, condenser unit sensors 114, and/or the ambient sensors 120 may send a signal to the processor 116. Based on the signal from the evaporator unit sensors 112, condenser unit sensors 114, and/or the ambient sensors 120, the processor 116 may cause the system 100 to cease operation, such as by sending a signal to the compressor 108 to stop. In some examples, based on the signal from the evaporator unit sensors 112, condenser unit sensors 114, and/or the ambient sensors 120, the processor 116 may send a signal to an alert or notification device, such as an alarm 122, to produce an audible, visual, or haptic warning to a user.

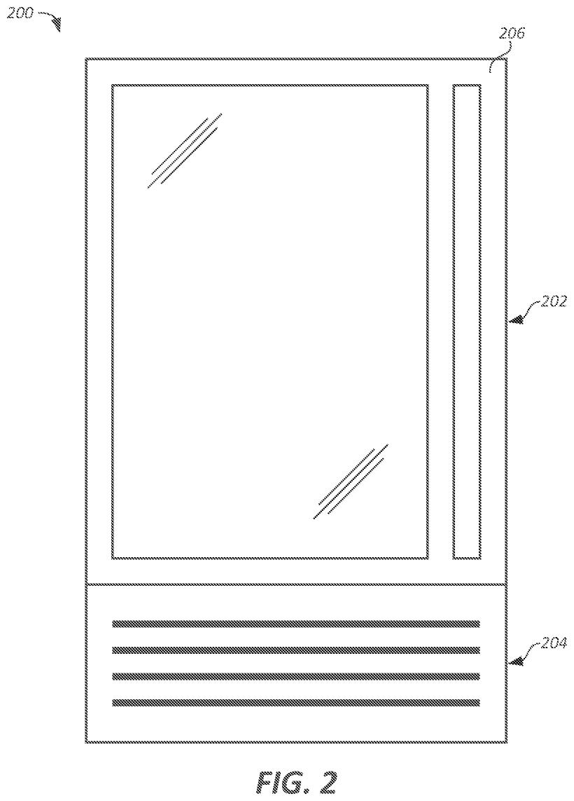

FIG. 2 is a front view of some examples of a refrigerator unit 200 which may utilize the refrigeration cycle system 100 of FIG. 1. In some examples, the refrigerator unit 200 may include a plurality of compartments. For example, as shown in FIG. 2, the refrigerator unit 200 may be divided into a first compartment, such as a refrigerated compartment 202, and a second compartment, such as a machinery compartment 204. In some examples, the evaporator 106 may be positioned inside the refrigerated compartment 202, while the compressor 108 and the condenser 110 may be positioned within the machinery compartment 204. In some examples, such as shown in FIG. 2, the refrigerated compartment 202 may include a door 206.

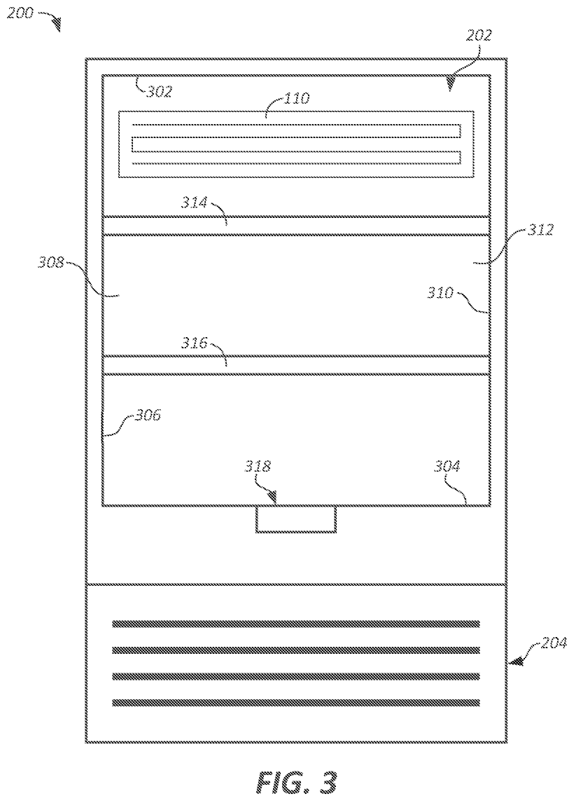

FIG. 3 is a front view of some examples of the refrigerator unit 200 of FIG. 2 with the door 206 removed. As illustrated in FIG. 3, some examples of the refrigerated compartment 202 may be formed by a top wall 302, a bottom wall 304, a first side wall 306, a rear wall 308, and a second side wall 310. The top wall 302, bottom wall 304, first side wall 306, rear wall 308, and second side wall 310 may define a cavity 312. In some examples, the condenser 110 and a plurality of shelves, such as first shelf 314 and second shelf 316, may be positioned within the cavity 312. During normal operation, the door 206 may be closed over the open side of the cavity 312 to substantially seal the interior of the cavity 312 from the outside environment. In various implementations, a recessed portion may be formed on a surface of the bottom wall 304. For example, the recessed portion may be formed on the surface of the bottom wall 304 facing the interior of the cavity 312. A sensor assembly 318 may be disposed within the recessed portion.

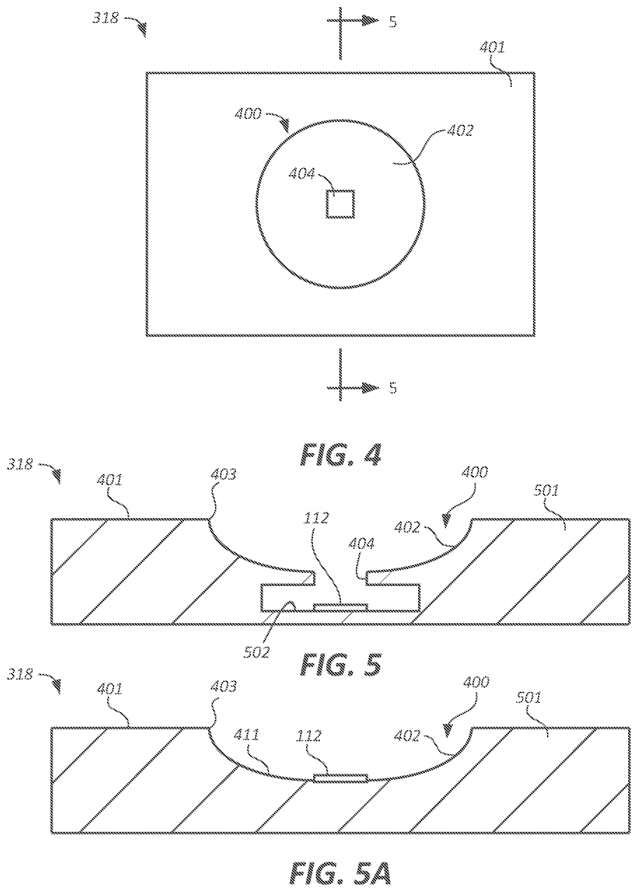

FIG. 4 is a top view of some examples of the sensor assembly 318 of FIG. 3. As illustrated in FIG. 4, the sensor assembly 318 may have a body 501 including an exterior surface 401. The sensor assembly 318 may include a recessed portion 402. The recessed portion 402 may have a curved, generally convex shape having an upwardly facing open end 403. Alternatively, or in addition, the recessed portion 402 may have a generally hemi-spherical shape. Still further, the recessed portion 402 may take the shape of a bowl. The recessed portion 402 may have a lowest portion or bottom 411 opposite the upwardly facing open end 403. The recessed portion 402 may be integral with the body 501 of the sensor assembly 318 and form a portion of the exterior surface 401. In some examples, the sensor assembly 318 may further include an opening 404 formed through a portion of the recessed portion 402, such as at the bottom 411of recessed portion 402.

FIG. 5 is a cross-sectional view of the sensor assembly 318 of FIG. 4, taken at line 5-5, and illustrating additional details that may be associated with some example embodiments of the sensor assembly 318. For example, according to some embodiments of the sensor assembly 318, an enclosed collection space 502 may be formed in the body 501 of the sensor assembly 318 and beneath the recessed portion 402. The opening 404 may adjoin the recessed portion 402 with the collection space 502. The sensor assembly 318 may include one or more refrigerant sensors 112, such as evaporator unit sensors, disposed within the collection space 502.

FIG. 5A is a sectional view illustrating additional details that may be associated with some examples of the sensor assembly 318. In some examples, the recessed portion 402 may not have an opening 404 or an enclosed collection space 502 beneath the recessed portion 402. In some examples of the sensor assembly 400, the evaporator unit sensors 112 may be disposed on a surface of the recessed portion 402, for example, at the lowest portion of the recessed portion 402.

In various implementations, the sensor assembly may not be a discrete unit, but integrally formed with the bottom wall 304 of the refrigerator unit 200. For example, the recessed portion 402 may be formed on a portion of the bottom wall 304, and the evaporator unit sensors 112 may be disposed on the surface of the recessed portion 402. In various implementations, the recessed portion 402 may be formed on a portion of the bottom wall 304, and the opening 404 may be formed through a portion of the recessed portion 402. The opening 404 may open into the enclosed collection space 502 formed beneath the bottom wall 304, and the evaporator unit sensors 112 may be disposed within the collection space 502.

The systems, apparatuses, and methods described herein may provide significant advantages. For example, the evaporator unit sensors 112 may detect the presence of A2L refrigerants within the refrigerated compartment 202. In order to detect low levels of refrigerant gas within the refrigerated compartment 202, the evaporator unit sensors 112 may be calibrated to detect levels of refrigerant in a range of between about 50 ppm to about 100 ppm. Because A2L refrigerants typically have a density greater than that of air, A2L refrigerants will tend to collect near the bottom of the refrigerated compartment 202, such as near the bottom wall 304. However, when the user opens the door 206, the collected A2L refrigerants may leak into the external ambient environment, or be diluted below the detection threshold of the evaporator unit sensors 112. By providing a sensor assembly 318 including a recessed portion 402 and/or a collection space 502, leaked refrigerant gases may collect near the bottom of the refrigerated compartment 202, such as within the recessed portion 402 and/or the collection space 502. The curved walls of the recessed portion 402 and/or the walls of the enclosed collection space 502 may substantially prevent refrigerant gases from escaping the refrigerated compartment 202 or being diluted with air from the external environment in response to the door 206 being opened. Thus, the sensor assembly 400 may facilitate the evaporator unit sensors 112 in detecting low levels of leaked refrigerant gases within the refrigerator compartment 202, even as the door 206 is opened and closed.

While shown in a few illustrative embodiments, a person having ordinary skill in the art will recognize that the systems, apparatuses, and methods described herein are susceptible to various changes and modifications that fall within the scope of the appended claims. Moreover, descriptions of various alternatives using terms such as “or” do not require mutual exclusivity unless clearly required by the context, and the indefinite articles “a” or “an” do not limit the subject to a single instance unless clearly required by the context. Components may be also be combined or eliminated in various configurations for purposes of sale, manufacture, assembly, or use.

The appended claims set forth novel and inventive aspects of the subject matter described above, but the claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

What is claimed is:

1. A refrigerant sensor assembly, comprising:
a body comprising an exterior surface;
a recessed portion formed in the body and comprising the exterior surface;
an enclosed collection space located beneath the recessed portion;
an opening formed through the recessed portion and adjoining the recessed portion with the collection space; and
a refrigerant sensor disposed in the collection space.

2. The refrigerant sensor assembly of claim 1 wherein the recessed portion comprises a curved, generally convex shape having an upwardly facing open end and a bottom positioned opposite to the upwardly facing open end.

3. The refrigerant sensor assembly of claim 2 wherein the recessed portion comprises a generally hemi-spherical shape.

4. The refrigerant sensor assembly of claim 2 wherein the recessed portion comprises a bowl shape.

5. The refrigerant sensor assembly of claim 2 wherein the recessed portion comprises a first volume; and
the collection space comprises a second volume that is smaller than the first volume of the recessed portion.

6. The refrigerant sensor assembly of claim 5 wherein the collection space comprises a bottom opposite to the opening; and
wherein the refrigerant sensor is disposed at the bottom of the collection space.

7. A refrigerator unit, comprising:
a refrigerated compartment comprising top wall, a bottom wall, and a plurality of side walls; and
the refrigerant sensor assembly of claim 6 disposed in the refrigerated compartment.

8. A refrigerator unit, comprising:
a refrigerated compartment comprising top wall, a bottom wall, and a plurality of side walls; and
the refrigerant sensor assembly of claim 1 disposed in the refrigerated compartment.

9. A refrigerant sensor assembly, comprising:
a body having an exterior surface;
a recessed portion formed in the body and comprising the exterior surface, the recessed portion comprising a generally convex shape with an upwardly facing open end and a bottom located opposite to the upwardly facing open end; and
a refrigerant sensor disposed in the recessed portion at the bottom of the recessed portion.

10. The refrigerant sensor assembly of claim 9 wherein the recessed portion comprises a generally hemi-spherical shape.

11. The refrigerant sensor assembly of claim 9 wherein the recessed portion comprises a bowl shape.

12. A refrigerator unit, comprising:
a refrigerated compartment comprising top wall, a bottom wall, and a plurality of side walls; and
the refrigerant sensor assembly of claim 11 disposed in the refrigerated compartment.

13. A refrigerator unit, comprising:
a refrigerated compartment comprising top wall, a bottom wall, and a plurality of side walls; and
the refrigerant sensor assembly of claim 9 disposed in the refrigerated compartment.
